(19) United States
(12) Patent Application Publication
(10) Pub. No.: US 2026/0019928 A1
(43) Pub. Date: Jan. 15, 2026

(54) TERMINAL

(71) Applicant: NTT DOCOMO, INC., Tokyo (JP)

(72) Inventors: Tianyang MIN, Tokyo (JP); Shoki INOUE, Tokyo (JP)

(73) Assignee: NTT DOCOMO, INC., Tokyo (JP)

(21) Appl. No.: 18/993,613

(22) PCT Filed: Jul. 20, 2022
(86) PCT No.: PCT/JP2022/028265

§ 371 Date: Jan. 13, 2025

(51) Int. Cl. H04W 48/16; H04W 48/18; H04W 84/06

(52) U.S. Cl. CPC H04W 48/16; H04W 48/18; H04W 84/06

(57) ABSTRACT

A terminal includes: a control unit that selects a first network forming a first cell, or a second network located at an altitude higher than the first network and forming a second cell as a network to which a terminal connects; and a transmission unit that transmits assistance information including information on the selected first network or the selected second network to a network.

### TECHNICAL FIELD

The present disclosure relates to a terminal that performs communication with a network.

### BACKGROUND

The 3rd Generation Partnership Project (3GPP: Registered Trademark) has prepared a specification for the 5th generation mobile communication system (which may be called 5G, New Radio (NR), or Next Generation (NG)), and is also in the process of specifying the next generation called Beyond 5G, 5G Evolution, or 6G.

In 3GPP Release 18, mobility enhancement and service enhancement in NTN (Non-Terrestrial Network) and TN (Terrestrial Network) have been studied (NON-PATENT LITERATURE 1).

TN is a network including a gNB (base station) and UE (user equipment: terminal), and TN cells are formed by the TN. NTN is a network in which at least some of devices constituting the NTN are located at an altitude higher than the TN, and the NTN cells are formed by the NTN. NTN is a network capable of providing services to an area (such as the ocean), which cannot be covered by the TN cells for reasons such as cost, by using a radio relay device located above in the sky.

### CITATION LIST

### Non-Patent Literature

NON-PATENT LITERATURE 1: “Revised WID: NR NTN (Non-Terrestrial Networks) enhancements”, RP-221819, 3GPP TSG RAN Meeting #96, Budapest, Hungary, Jun. 6 to 9, 2022

### SUMMARY OF THE INVENTION

However, according to the related art, there is a possibility that the UE residing in the area that cannot be covered by a TN cell continues searching the TN cell even though the UE is located outside the coverage area of the TN cell. In order to prevent such a situation, in a case where the UE remains configured to cancel the search for the TN cell, there is a possibility that the UE continues searching an NTN cell even if moving from the coverage area of the NTN cell to the coverage area of the TN cell. As a result, the UE continues connecting to the NTN cell even though the UE is in an environment in which the UE can connect to the TN cell, and thereby there may be concerns about a decrease in communication speed and an increase in terminal power consumption compared to the case where the UE connects to the TN cell.

Therefore, the following disclosure has been made in view of such a situation, and aims to provide a terminal capable of stopping unnecessary communication while appropriately performing communication with a TN cell or an NTN cell.

An aspect of the present disclosure is a terminal including: a control unit that selects a first network forming a first cell, or a second network located at an altitude higher than the first network and forming a second cell as a network to which a terminal connects; and a transmission unit that transmits assistance information including information on the selected first network or the selected second network to a network.

An aspect of the present disclosure is a terminal including: a terminal including: a control unit that determines whether a quality of a first cell formed by a first network is higher than a threshold value; and a reception unit that stops a frequency measurement of a second cell formed by a second network located at an altitude higher than the first network when determining that a quality of the first cell is higher than a threshold value.

### BRIEF DESCRIPTION OF DRAWINGS

FIG. 1 is an overall schematic diagram of a radio communication system 10 according to a present embodiment.

FIG. 2 is a diagram illustrating the frequency ranges used in the radio communication system 10.

FIG. 3 is a diagram illustrating a configuration example of radio frames, sub-frames, and slots used in the radio communication system 10.

FIG. 4 is a functional block diagram of UE 200.

FIG. 5 is a functional block diagram of gNB 100.

FIG. 6 is a diagram explaining a protocol.

FIG. 7 is a diagram explaining a problem when the UE 200 properly performs communication with a TN cell or an NTN cell.

FIG. 8 is a diagram explaining operation example 2.

FIG. 9 is a diagram explaining a communication sequence example of operation example 1.

FIG. 10 is a diagram explaining a communication sequence example of operation example 5.

FIG. 11 is a diagram illustrating an example of a hardware configuration of the gNB 100 and the UE 200.

FIG. 12 is a diagram illustrating a configuration example of a vehicle 2001.

FIG. 13A is a diagram explaining an example of an indicator of NTN or TN in SIB3, SIB4, or the like.

FIG. 13B is a diagram explaining an example of an indicator of NTN or TN in SIB3, SIB4, or the like.

FIG. 13C is a diagram explaining an example of an indicator of NTN or TN in SIB3, SIB4, or the like.

FIG. 13D is a diagram explaining an example of an indicator of NTN or TN in SIB3, SIB4, or the like.

FIG. 13E is a diagram explaining an example of an indicator of NTN or TN in SIB3, SIB4, or the like.

FIG. 13F is a diagram explaining an example of an indicator of NTN or TN in SIB3, SIB4, or the like.

FIG. 13G is a diagram explaining an example of an indicator of NTN or TN in SIB3, SIB4, or the like.

FIG. 13H is a diagram explaining an example of an indicator of NTN or TN in SIB3, SIB4, or the like.

### DETAILED DESCRIPTION OF THE INVENTION

An embodiment will be described below with reference to the drawings. Note that the same or similar reference numerals have been attached to the same functions and configurations, and a description thereof will be omitted as appropriate.

### Embodiment

### (1) Overall Schematic Configuration of Radio Communication System

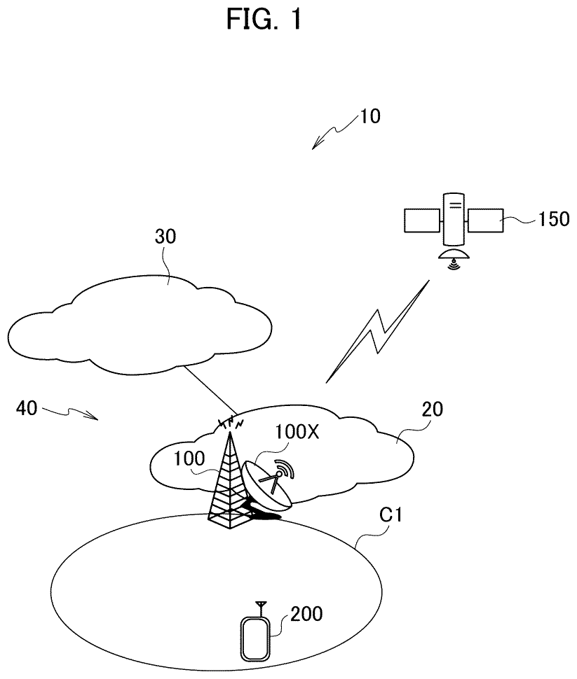

FIG. 1 is an overall schematic diagram of a radio communication system 10 according to the present embodiment. The radio communication system 10 is a radio communication system according to 5G New Radio (NR), and includes a Next Generation-Radio Access Network 20 (hereinafter, referred to as NG-RAN 20) and a terminal 200 (hereinafter, referred to as User Equipment (UE) 200). The radio communication system 10 may be a radio communication system according to a scheme called Beyond 5G, 5G Evolution, or 6G. The radio communication system 10 may include a gNB 100, the UE 200, the NG-RAN 20, and a core network 30.

The NG-RAN 20 includes a radio base station 100 (hereinafter, gNB 100). The NG-RAN 20 actually includes a plurality of NG-RAN nodes, specifically gNBs (or ng-eNBs), and is connected to the core network 30 (for example, 5GC) according to 5G. The NG-RAN 20 and 5GC may be simply referred to as a “network”. The specific configuration of the radio communication system 10 including the gNB 100 and UE 200 is not limited to the example illustrated in FIG. 1.

The gNB 100 is a radio base station according to 5G, and performs radio communication with the UE 200 according to 5G. The gNB 100 and the UE 200 can support Massive MIMO (Multiple-Input Multiple-Output) that generates a beam BM with higher directivity by controlling radio signals transmitted from a plurality of antenna elements, carrier aggregation (CA) that uses a plurality of component carriers (CCs) bundled together, dual connectivity (DC) that simultaneously performs communication to two or more transport blocks between the UE and each of the two NG-RAN nodes, and the like.

The core network 30 includes a network device. The network device may include an LMF (Location Management Function), an AMF (Access and Mobility Management Function), and the like. The network device may be an E-SMLC (Evolved Serving Mobile Location Centre). The gNB 100 constitutes the radio communication node 40.

In the present embodiment, the radio communication system 10 may include a non-terrestrial network (NTN). In the NTN, an artificial satellite 150 (hereinafter, referred to as satellite 150) or the like is used to provide services to an area that cannot be covered by the terrestrial network (TN) for reasons such as cost. The NTN may include HAPS (High Altitude Platform Station) in addition to the satellite 150. The HAPS may include airships, balloons, drones, and the like.

The network including the gNB 100 and the UE 200, but not including the satellite 150 or the like, may be called a terrestrial network (TN) in contrast to the NTN. The TN may be interpreted as a first network provided on the ground or on the land surface. The TN may be interpreted as a first network provided near the ground or the land surface.

The NTN may be interpreted as a second network in which at least some of devices constituting the NTN are located at an altitude higher than the TN. The NTN may be interpreted as a second network located above the TN. The NTN may be interpreted as a second network located at a high altitude based on the land surface. The cells formed by the NTN can be interpreted as moving cells. The moving cells can be interpreted as quasi-earth-fixed cells (see 3GPP TSG-RAN WG2 Meeting #112-e, R2-2010765). The moving cells can be interpreted as earth-moving cells (see 3GPP TSG-RAN WG2 Meeting #108, R2-1916240). The moving cells can be interpreted as the cells formed by the NTN located at a high altitude.

The NTN can provide more reliable services. For example, the NTN is expected to be applied to IoT (Inter of things), ships, buses, trains, and critical communications. The NTN also have efficient multicast or broadcast scalability.

The network including the gNB 100 and the UE 200, but not including the satellite 150, may be called a terrestrial network (TN) in contrast to the NTN.

The gNB 100 has an NTN gateway 100X. The NTN gateway 100X transmits downlink signals to the satellite 150. The NTN gateway 100X receives uplink signals from the satellite 150. The gNB 100 has a cell C1 as a coverage area. The gNB 100 may have a node (not illustrated) adjacent to the cell C1 as a coverage area.

The satellite 150 relays the downlink signals received from the NTN gateway 100X to the UE (not illustrated). The satellite 150 relays the uplink signals received from the UE (not illustrated) to the NTN gateway 100X. The satellite 150 may be considered to be a transmission-reception point (TRP).

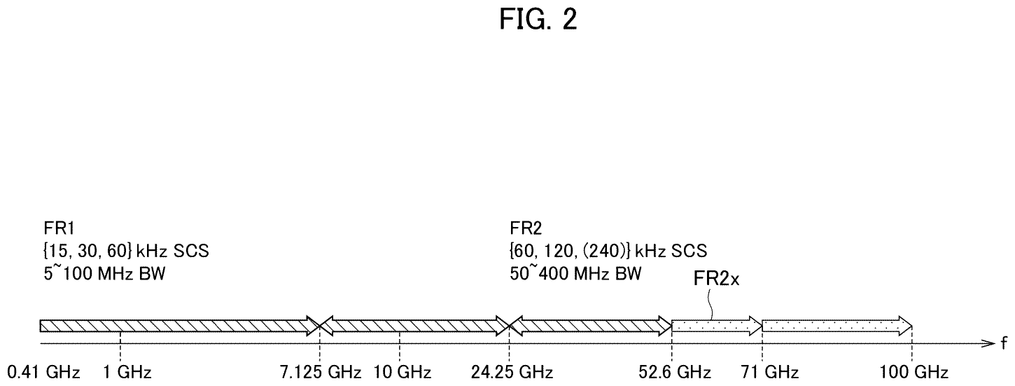

The radio communication system 10 supports a plurality of frequency ranges (FR). FIG. 2 illustrates the frequency ranges used in the radio communication system 10.

As illustrated in FIG. 2, the radio communication system 10 supports the plurality of frequency ranges (FR).

Specifically, the radio communication system 10 may support the following frequency ranges:
FR1: 410 MHz to 7.125 GHZ
FR2: 24.25 MHz to 52.6 GHZ

In FR1, sub-carrier spacing (SCS) of 15, 30 or 60 kHz may be used, and a bandwidth (BW) of 5 to 100 MHz may be used. FR2 has a higher frequency than FR1, and SCS of 60 or 120 kHz (may include 240 kHz) may be used, and a bandwidth (BW) of 50 to 400 MHz may be used.

The SCS may be interpreted as numerology. The numerology is defined in 3GPP TS38.300, and corresponds to one sub-carrier spacing in the frequency domain.

Further, the radio communication system 10 also supports a higher frequency band than that of FR2. Specifically, the radio communication system 10 supports a frequency band exceeding 52.6 GHZ and up to 71 GHz or 114.25 GHz. Such a higher frequency band may be referred to as “FR2x” for the sake of convenience.

In order to solve the problem that the effect of phase noise becomes large in a high frequency band, when a band exceeding 52.6 GHz is used, Cyclic Prefix-Orthogonal Frequency Division Multiplexing (CP-OFDM)/Discrete Fourier Transform-Spread (DFT-S-OFDM) having larger sub-carrier spacing (SCS) may be applied. In addition, when a band exceeding 52.6 GHz is used, Cyclic Prefix-Orthogonal Frequency Division Multiplexing (CP-OFDM)/Discrete Fourier Transform-Spread (DFT-S-OFDM) having larger sub-carrier spacing (SCS) may be applied.

In a high frequency band such as FR2x, the increase of phase noise between carriers becomes a problem as described above. Therefore, it may be necessary to apply larger (wider) SCS or a single carrier waveform. The symbol/CP (Cyclic Prefix) period and slot period becomes shorter as the SCS becomes lager (when the 14 symbol/slot configuration is maintained).

When the 14 symbol/slot configuration is maintained, the symbol period (and slot period) becomes shorter as the SCS becomes larger (wider). The symbol period may be called a symbol length, a time direction, a time domain, or the like. The frequency direction may be called a frequency domain, a resource block, a subcarrier, a BWP (Bandwidth part), or the like.

The frequency resource may include a component carrier, a subcarrier, a resource block (RB), a resource block group (RBG), a BWP (Bandwidth part), and the like. The time resource may include a symbol, a slot, a minislot, a subframe, a radio frame, a DRX (Discontinuous Reception) period, and the like.

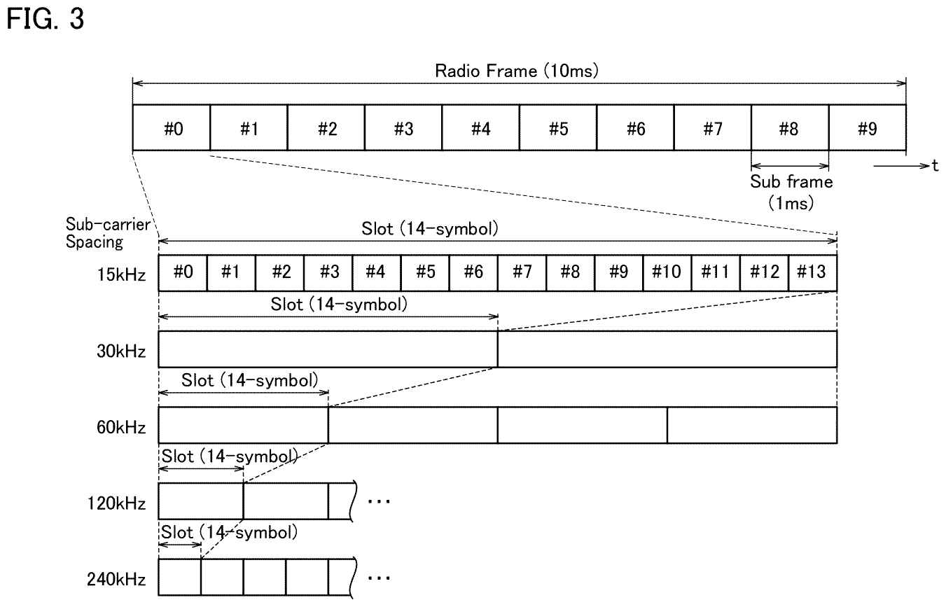

FIG. 3 illustrates a configuration example of radio frames, subframes, and slots used in the radio communication system 10.

As illustrated in FIG. 3, one slot is constituted of 14 symbols, and, the symbol period (and slot period) becomes shorter as the SCS becomes larger (wider). The SCS is not limited to the spacing (frequency) illustrated in FIG. 3. For example, 480 kHz, 960 kHz, or the like may be used.

Note that the number of symbols constituting one slot may not necessarily be 14 symbols (for example, 28 or 56 symbols). Further, the number of slots for each subframe may vary depending on the SCS.

Note that the time direction (t) illustrated in FIG. 3 may be referred to as a time domain, a symbol period, symbol time, or the like. The frequency direction may be referred to as a frequency domain, a resource block, a sub-carrier, a bandwidth part (BWP), or the like.

A DMRS is a type of reference signal and is prepared for various channels. Here, unless otherwise specified, it may mean a DMRS for a downlink data channel, specifically, for a PDSCH (Physical Downlink Shared Channel). However, a DMRS for an uplink data channel, specifically, for a PUSCH (Physical Uplink Shared Channel), may be interpreted in the same way as a DMRS for a PDSCH.

The DMRS may be used in a device, for example, in the UE 200 for channel estimation as part of coherent demodulation. The DMRS may be present only in a resource block (RB) used for PDSCH transmission.

The DMRS may have multiple mapping types. Specifically, the DMRS has mapping type A and mapping type B. In mapping type A, a first DMRS is arranged on the second or third symbol of the slot. In mapping type A, the DMRS may be mapped based on the slot boundaries, regardless of where the actual data transmission starts in the slot. The reason why the first DMRS is arranged on the second or third symbol of the slot may be interpreted because the first DMRS is arranged after control resource sets (CORESET).

In mapping type B, a first DMRS may be arranged on the first symbol of the data allocation. That is, the position of the DMRS may be provided relative to where the data is arranged, rather than relative to the slot boundaries.

In addition, the DMRS may have multiple types. Specifically, the DMRS has Type 1 and Type 2. Type 1 and Type 2 differ in mapping in the frequency domain and in the maximum number of orthogonal reference signals. In Type 1, up to 4 orthogonal signals can be output with a single-symbol DMRS, and in Type 2, up to 8 orthogonal signals can be output with a double-symbol DMRS.

### (2) Functional Block Configuration of Radio Communication System 10

Next, a functional block configuration of the radio communication system 10 will be described.

First, a functional block configuration of the UE 200 will be described.

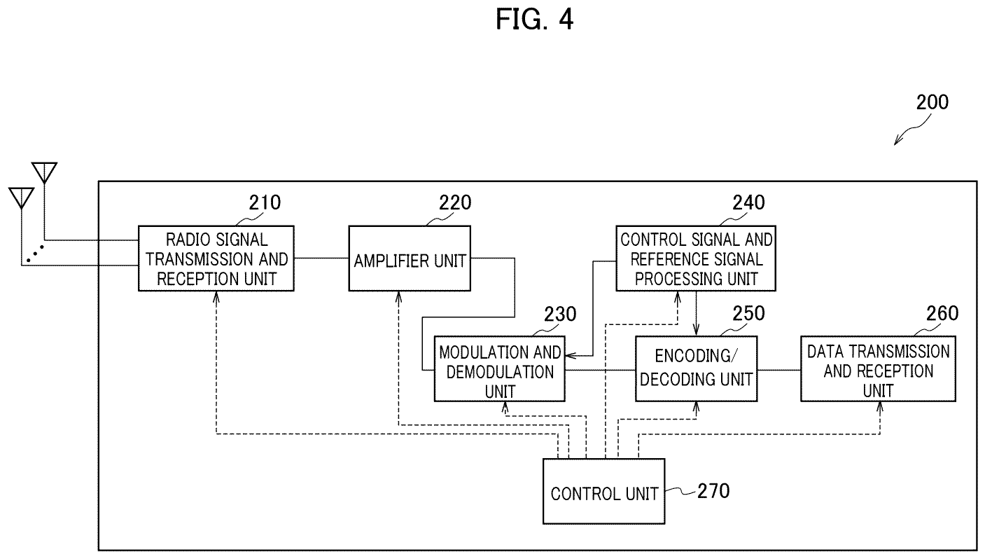

FIG. 4 is a functional block diagram of the UE 200. As illustrated in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

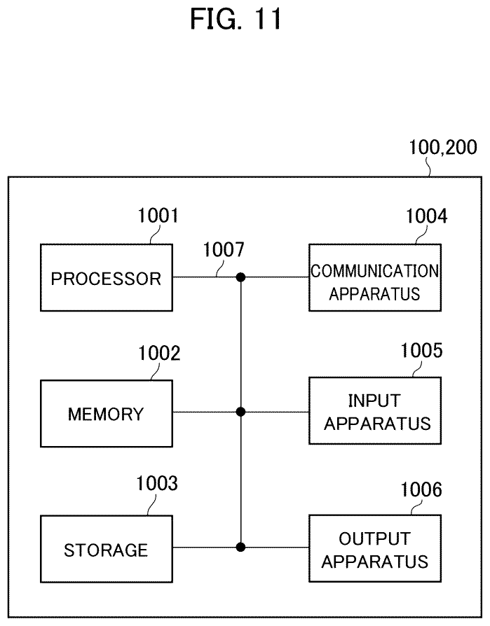

Note that only the main functional blocks related to the description of the embodiment are illustrated in FIG. 4, and the UE 200 includes other functional blocks (for example, power supply unit). In addition, FIG. 4 illustrates a functional block configuration of the UE 200, and please refer to FIG. 11 for a hardware configuration.

The radio signal transmission and reception unit 210 transmits and receives radio signals according to NR. The radio signal transmission and reception unit 210 supports Massive MIMO that generates a beam BM with high directivity by controlling radio (RF) signals transmitted from a plurality of antenna elements, carrier aggregation (CA) that uses a plurality of component carriers (CCs) bundled together, DC that simultaneously performs communication between the UE and each of two NG-RAN nodes, and the like.

The amplifier unit 220 includes a PA (Power Amplifier)/LNA (Low Noise Amplifier) and the like. The amplifier unit 220 amplifies a signal output from the modulation and demodulation unit 230 to a predetermined power level. The amplifier unit 220 also amplifies an RF signal output from the radio signal transmission and reception unit 210.

The modulation and demodulation unit 230 performs data modulation and demodulation, a transmission power configuration, a resource block allocation, and the like for each predetermined communication destination (gNB 100 or another gNB). Cyclic Prefix-Orthogonal Frequency Division Multiplexing (CP-OFDM)/Discrete Fourier Transform-Spread (DFT-S-OFDM) may be applied in the modulation and demodulation unit 230. In addition, DFT-S-OFDM may be used not only for an uplink (UL), but also for a downlink (DL).

The control signal and reference signal processing unit 240 performs processing regarding various control signals transmitted and received by the UE 200, and processing regarding various reference signals transmitted and received by the UE 200.

Specifically, the control signal and reference signal processing unit 240 receives various control signals transmitted from the gNB 100 via a predetermined control channel, for example, the control signals for the radio resource control layer (RRC). The control signal and reference signal processing unit 240 also transmits various control signals to the gNB 100 via a predetermined control channel.

The control signal and reference signal processing unit 240 performs processing using a reference signal (RS), such as a demodulation reference signal (DMRS) and a phase tracking reference signal (PTRS). The DMRS is a UE 200-specific reference signal (pilot signal) for estimating a fading channel used for data demodulation, known between a base station and the UE 200. The PTRS is a UE 200-specific reference signal for the purpose of estimating phase noise which becomes a problem in a high frequency band.

The reference signals may include, in addition to the DMRS and the PTRS, a channel state information-reference signal (CSI-RS), a sounding reference signal (SRS), and a positioning reference signal (PRS) for positional information.

The channels include control channels and data channels. The control channels may include a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI)), a Physical Broadcast Channel (PBCH), and the like.

In addition, the data channels may include a PDSCH (Physical Downlink Shared Channel), a PUSCH (Physical Uplink Shared Channel), and the like. Data refers to data transmitted via the data channel. The data channels may be read as shared channels.

The control signal and reference signal processing unit 240 may receive downlink control information (DCI). The DCI includes, as existing fields, fields for storing DCI Formats, a Carrier indicator (CI), a BWP indicator, an FDRA (Frequency Domain Resource Assignment), a TDRA (Time Domain Resource Assignment), an MCS (Modulation and Coding Scheme), an HPN (HARQ Process Number), an NDI (New Data Indicator), an RV (Redundancy Version), and the like.

The value stored in the DCI Format field is an information element to specify a format of the DCI. The value stored in the CI field is an information element to specify a CC to which the DCI is applied. The value stored in the BWP indicator field is an information element to specify a BWP to which the DCI is applied. The BWP that can be specified by a BWP indicator is configured by an information element (BandwidthPart-Config) included in an RRC message. The value stored in the FDRA field is an information element to specify a frequency domain resource to which the DCI is applied. The frequency domain resource is specified by a value stored in the FDRA field and an information element (RA Type) included in the RRC message. The value stored in the TDRA field is an information element to specify a time domain resource to which the DCI is applied. The time domain resource is specified by a value stored in the TDRA field and an information element (pdsch-TimeDomainAllocationList, pusch-TimeDomainAllocationList) included in the RRC message. The time domain resource may be specified by a value stored in the TDRA field, and by a default table. The value stored in the MCS field is an information element to specify an MCS to which the DCI is applied. The MCS is specified by a value stored in the MCS, and by an MCS table. The MCS table may be specified by an RRC message, or specified by RNTI scrambling. The value stored in the HPN field is an information element to specify a HARQ process to which the DCI is applied. The value stored in the NDI is an information element to specify whether the data to which the DCI is applied is the initial transmission data. The value stored in the RV field is an information element to specify the redundancy of data to which the DCI is applied.

In the present embodiment, the control signal/reference signal processing unit 240 may include a transmission unit that transmits to the network, the assistance information including information on a network that gives priority to connection by the UE 200 when the UE 200 connects to the cell selected by the control unit 270.

In the present embodiment, the control signal/reference signal processing unit 240 may include a transmission unit that transmits the assistance information to the network, if the distance from the cell or the base station, which is adjacent to the cell in which the UE 200 resides, to the UE 200 is shorter than a threshold value when the UE 200 connects to the cell selected by the control unit 270.

In the present embodiment, the control signal/reference signal processing unit 240 may include a reception unit that stops a frequency measurement of a second cell located above a first cell when the control unit 270 determines that the quality of the first cell is higher than a threshold value.

In the present embodiment, the control signal/reference signal processing unit 240 may include a reception unit that starts a frequency measurement of the second cell when the UE 200 is in a “camped on any cell” state in the first cell.

The encoding/decoding unit 250 performs data division/concatenation, channel coding/decoding, and the like for each predetermined communication destination (gNB 100 or another gNB). Specifically, the encoding/decoding unit 250 divides the data output from the data transmission and reception unit 260 into predetermined sizes, and performs channel coding on the divided data. The encoding/decoding unit 250 also decodes the data output from the modulation and demodulation unit 230, and concatenates the decoded data.

The data transmission and reception unit 260 transmits and receives a protocol data unit (PDU) and a service data unit (SDU). Specifically, the data transmission and reception unit 260 performs assembly/disassembly of PDU/SDU in a plurality of layers (a media access control layer (MAC), a radio link control layer (RLC), a packet data convergence protocol layer (PDCP) and the like). In addition, the data transmission and reception unit 260 performs error correction and retransmission control of data based on HARQ (Hybrid Automatic Repeat Request).

The control unit 270 controls each of functional blocks constituting the UE 200.

In the present embodiment, the control unit 270 may include a control unit that selects a first network forming a first cell, or a second network located at an altitude higher than the first network and forming a second cell as the network to which the UE 200 connects.

In the present embodiment, the control unit 270 may include a control unit that determines whether a quality of the first cell is higher than a threshold value when the UE 200 connects to the first cell formed by the first network.

In the present embodiment, the control unit 270 may include a control unit that receives a system information block (SIB) including type information indicating a type of a cell adjacent to the cell in which the UE 200 resides.

In the present embodiment, the control unit 270 may include a control unit that starts a measurement of the second cell if a distance from the cell or the base station, which is adjacent to the cell in which the UE 200 resides, to the UE 200 is longer than a threshold value.

In the radio communication system 10, an SSB (SS/PBCH Block) constituted of a synchronization signal (SS) and a downlink physical broadcast channel (PBCH) may be used.

The SSB is mainly transmitted from the network periodically in order for the UE 200 to perform detection of cell ID and reception timing at the start of communication. In NR, the SSB is reused to measure the reception quality of each cell. 5, 10, 20, 40, 80, 160 milliseconds or the like may be defined as the transmission period (periodicity) of the SSB. The UE 200 for initial access may be assumed to have a transmission period of 20 milliseconds.

Second, a functional block configuration of the gNB 100 will be described.

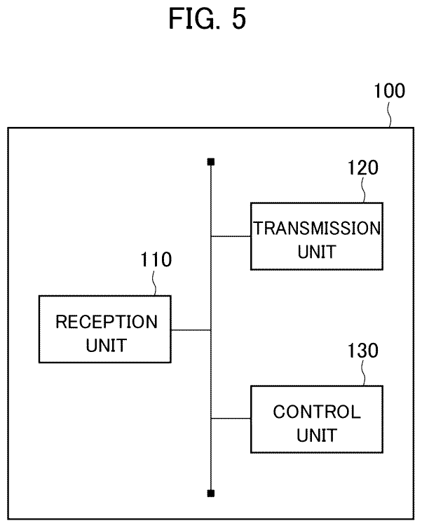

FIG. 5 is a functional block diagram of the gNB 100. As illustrated in FIG. 5, the gNB 100 includes a reception unit 110, a transmission unit 120, and a control unit 130.

The reception unit 110 receives various signals from the UE 200. The reception unit 110 may receive UL signals via PUCCH or PUSCH.

The transmission unit 120 transmits various signals to the UE 200. The transmission unit 120 may transmit DL signals via PDCCH or PDSCH. The transmission unit 120 may transmit two or more downlink positioning reference signals (DL-PRSs) at different timings on a time axis via NTN.

The control unit 130 controls the gNB 100.

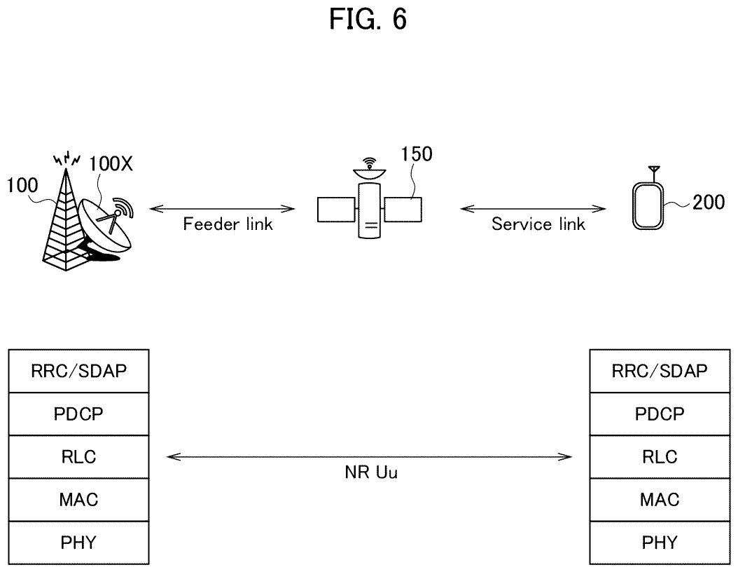

A protocol will be described with reference to FIG. 6. FIG. 6 is a diagram explaining the protocol. As illustrated in FIG. 6, the gNB 100 has a protocol stack such as PHY, MAC, RLC, PDCP, and RRC/SDAP. Similarly, the UE 200 has a protocol stack such as PHY, MAC, RLC, PDCP, and RRC/SDAP. The satellite 150 relays communications between the gNB 100 and the UE 200.

The link between the gNB 100 (NTN gateway 100X) and the satellite 150 may be referred to as a feeder link. The link between the satellite 150 and the UE 200 may be referred to as a service link. The interface between the gNB 100 and the UE 200 may be referred to as NR Uu.

The network architecture of the NTN may be assumed to employ FDD or TTD. The cells on the ground may be fixed or movable. The UE 200 may have capability to support a Global Navigation Satellite System (GNSS). The UE 200 may be assumed to be a handheld device of power class 3 in FR1, and a very small aperture terminal (VSAT) in at least FR2.

The network architecture of NTN may be assumed to be a regenerative payload. For example, a function of the gNB 100 may be mounted on a satellite or a vehicle. In addition, gNB-DU (distributed unit) may be mounted on a satellite or a vehicle, and gNB-CU (central unit) may be deployed as a ground station.

### (3) Operation of Radio Communication System 10

Next, an operation of the radio communication system 10 will be described. Specifically, an operation example of the radio communication system 10 including the UE 200 capable of stopping unnecessary communication while appropriately performing communication with a cell formed by a TN (TN cell) or a cell formed by an NTN (NTN cell) will be described.

### (3.1) Assumption and Problem

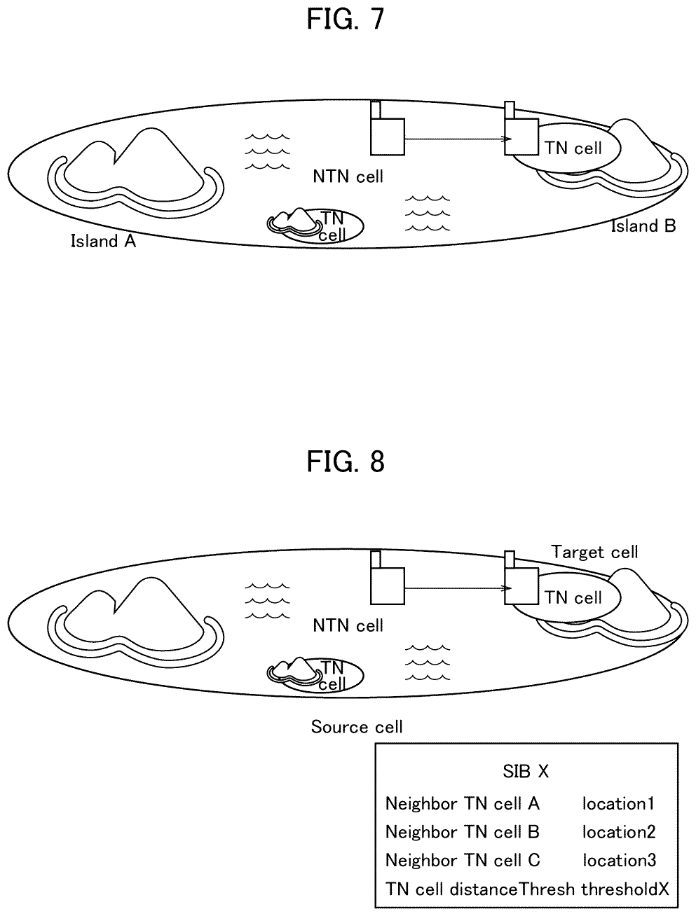

A problem when the UE 200 appropriately performs communication with a TN cell or an NTN cell will be described with reference to FIG. 7.

FIG. 7 is a diagram explaining a problem when the UE 200 appropriately performs communication with a TN cell or an NTN cell. FIG. 7 illustrates a coverage area of the NTN cell, a coverage area of the TN cell provided in “Island B”, and the UE located outside the coverage area of the TN cell.

As illustrated in FIG. 7, when the UE existing on the sea is located outside the coverage area of the TN cell, there is a possibility that the UE continues searching the TN cell for connection to the TN cell even though the UE is located outside the coverage area of the TN cell.

In order to prevent such a situation, in a case where the UE remains configured to cancel the search of the TN cell, there is a possibility that the UE continues searching the NTN cell even if the UE moves to the coverage area of the TN cell as illustrated in FIG. 7. As a result, the UE continues connecting to the NTN cell even though the UE is in an environment in which the UE can connect to the TN cell, and thereby there may be concerns about a decrease in communication speed and an increase in terminal power consumption compared to the case where the UE connects to the TN cell.

As a solution to such a problem, there are plurality of operation examples that can stop unnecessary communication while appropriately performing communication with the TN cell or the NTN cell as described below. The plurality of operation examples described later may be used individually or in combination with two or more.

### (3.2) Operation Examples

Hereinafter, the operation examples that can solve the problem illustrated in FIG. 7 will be described.

### (3.2.1) Operation Example 1

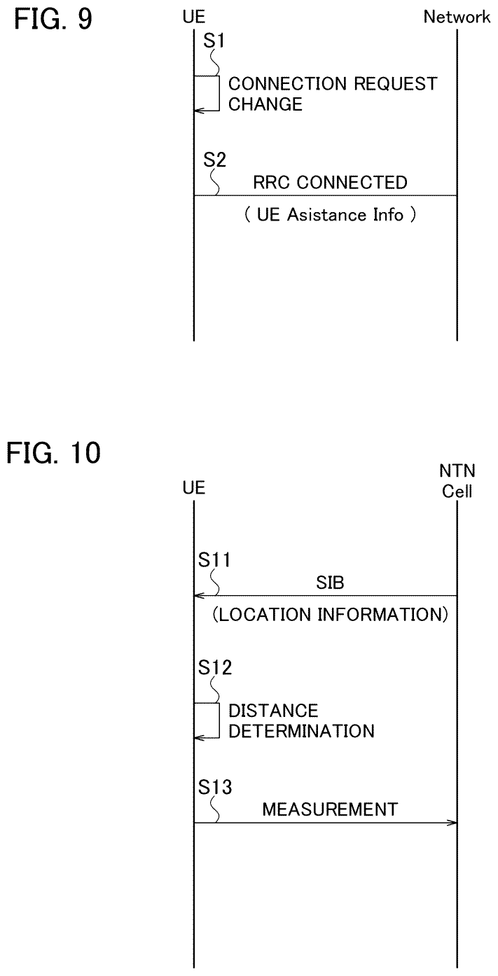

FIG. 9 is a diagram explaining a communication sequence example of operation example 1. Here, an operation of the UE 200 and the network when the user changes the network to be connected with priority will be described.

When the user of the UE 200 manually selects the network (NTN or TN) to be connected with priority, the transmission unit of the UE 200 changes a connection request to the network (NTN or TN) to be connected with priority (step S2). The transmission unit of the UE 200 may transmit to the network (NTN or TN) the UEAsistanceInfo including a preference in RRC_CONNECTED (step S2). The transmission unit of the UE 200 may transmit to the network (NTN or TN) a measurement report including the preference.

The preference may be interpreted as information about the network (TN or NTN) selected by the control unit. The preference may be interpreted as information about the network (TN or NTN) that gives priority to the connection of the UE 200. The preference may be interpreted as information for identifying the network (NTN or TN) to which the UE 200 preferentially requests the connection.

Specifically, when the user of the UE 200 operates the UE 200 to select the network (NTN or TN) to be connected with priority by using a function provided by the OS or an application of the UE 200, the control unit of the UE 200 may select a first cell (TN cell) formed by a first network (TN), or a second cell (NTN cell) formed by a second network (NTN) which is located at an altitude higher than the first network.

The transmission unit of the UE 200 may include the preference described above in the assistance information (UEAsistanceInfo) and transmit it to the network when the UE 200 connects to the cell selected by the control unit (in RRC_CONNECTED).

According to operation example 1, when the user optionally selects a network to be connected with priority, unnecessary communication with an unselected network can be suppressed while communicating with the selected network. For this reason, when the connection to the TN is selected, the connection of the UE 200 to the NTN can be stopped. Therefore, the consumption of radio resources (frequency bandwidth, transmission power, and the like.) in the UE 200 in order for the UE 200 to continue communication with the NTN can be suppressed. In addition, when the connection to the NTN is selected, the connection of the UE 200 to the TN can be stopped. Therefore, the consumption of radio resources in the UE 200 for the UE 200 to continue communication with the TN can be suppressed.

In addition, according to operation example 1, since the user can optionally select the network to be connected, the use according to the user's purpose can be realized, and also a processing load can be reduced in the processor of the UE 200.

### (3.2.2) Operation Example 2

FIG. 8 is a diagram explaining operation example 2. Here, an operation of the UE 200 that turns OFF (stops, cancels) a frequency measurement of an unconnected network when the UE 200 connects to the NTN or TN will be described.

FIG. 8 illustrates a coverage area of an NTN cell, a coverage area of a TN cell provided in “Island B”, and the UE located outside the coverage area of the TN cell. FIG. 8 illustrates a state in which the UE 200 existing in the coverage area of the NTN cell is approaching the coverage area of the TN cell. In operation example 2, it may be assumed that the UE 200 performs a handover from the NTN cell (for example, a source cell) to the TN cell (for example, a target cell).

The UE 200 in connection to the NTN may turn OFF (stop) a frequency measurement of the TN performed by the UE 200. Specifically, as illustrated in FIG. 8, when the UE 200 connects to the NTN at a location far from the TN, the control unit of the UE 200 may automatically change the frequency measurement of the TN from ON to OFF.

This makes it possible to suppress the consumption of radio resources in the UE 200 for the TN cell search while performing communication with the NTN, and also to suppress the amount of communication between the TN cell and the UE 200.

### Option 1

The UE 200 may turn OFF a frequency measurement of the TN after determining whether the quality of the TN cell is higher than a predetermined threshold value. Specifically, the UE determines whether the quality of the TN cell is higher than a predetermined threshold value, and if the quality of the TN cell is lower than a predetermined threshold value as a result of the determination, the UE may turn OFF the frequency measurement of the TN.

### Option 1-1

The UE 200 may turn OFF a frequency measurement of the TN when the quality of the TN cell changes from a state higher than a predetermined threshold value to a state lower than a predetermined threshold value.

### Option 1-2

The UE 200 may turn OFF a frequency measurement of the TN if the quality of the TN cell remains lower than a predetermined threshold value until a certain time elapses after the quality of the TN cell changes from a state higher than a predetermined threshold value to a state lower than a predetermined threshold value.

By determining the quality of the TN cell, as in option 1, if the quality of the TN cell remains higher than a predetermined threshold value, it is possible that the frequency measurement of the TN remains ON. In this case, the UE 200 may stop connecting to the NTN after connecting to the TN.

### Option 2

If the quality of a camped cell (residing cell) is higher than a predetermined threshold value, the UE 200 in connection to the TN may turn OFF (stop) a frequency measurement of the NTN. Specifically, when the UE 200 resides in the TN cell illustrated in FIG. 8, if the quality of the TN cell is higher than a predetermined threshold value, the UE 200 may turn OFF the frequency measurement of the NTN. The quality may be interpreted as Srxlev and/or Squal (see 3GPP TS38.304 V15.1.0 § 5.2.3.2). The quality may be interpreted as RSRP (Reference Signal Received Power), RSRQ (Reference Signal Received Quality), or SINR (Signal-to-interference plus Noise power Ratio). RSRP may be interpreted as the received power of the reference signal measured at the UE 200. RSRQ may be interpreted as the received quality of the reference signal measured at the UE 200. The received quality may be interpreted as a ratio between the power of the cell-specific reference signal and the total power within the receive bandwidth. SINR may be interpreted as a power ratio of the sum of noise and interference power to the signal.

Specifically, the control unit of the UE 200 may determine whether the quality of the first cell (TN cell) formed by the first network (TN) is higher than a predetermined threshold value when the UE 200 connects to the TN, the first cell (TN cell) formed by the first network (TN).

When the control unit of the UE 200 determines that the quality of the camped cell (TN cell) is higher than a predetermined threshold value, the reception unit of the UE 200 may change the frequency measurement of the second cell (NTN cell), which is formed by the second network (NTN) located at an altitude higher than the TN, from ON (continue) to OFF (stop).

Further, when the control unit of the UE 200 determines that the quality of the camped cell (TN cell) is lower than a threshold value, the reception unit of the UE 200 may turn ON (continue) the frequency measurement of the NTN cell.

### Option 3

When the UE 200 is in a “camped on any cell” state in which UE 200 resides on any cell (see 3GPP TS 38.304V15. 1. 0 § 3.1), the UE 200 may start or restart a frequency measurement of the NTN.

Specifically, when the UE 200 is in a “camped on any cell” state in the first cell (TN cell), the reception unit of the UE 200 may restart a frequency measurement of the second cell (NTN cell).

“Camped on any cell” may be interpreted as a state in which the UE 200 resides (camped on) in any TN cell when it is difficult to search the TN cell whose quality exceeds a predetermined threshold value. “Camped on any cell” may be interpreted as a state in which the UE 200 has completed the cell selection/re-selection processing in an idle mode and selects any cell irrespective of a PLMN ID, or resides on any cell. “Camped on any cell may be interpreted as a state in which the UE 200 has completed the cell selection/re-selection processing in an RRC INACTIVE mode and selects any cell irrespective of a PLMN ID, or resides on any cell.

Thus, in a case where the UE 200 is in a “camped on any cell” state in any TN cell, the UE 200 can connect to the NTN, instead of the TN cell whose quality is low, by restarting the frequency measurement of the NTN. Therefore, the consumption of radio resources in the UE 200 can be suppressed by stopping the connection to the TN cell while ensuring communication with the NTN.

### (3.2.3) Operation Example 3

An operation example in which the UE 200 attempts to connect to the NTN when the RRC connection to the TN is not possible will be described.

The UE 200 may turn ON the NTN cell search and/or the NTN cell measurement when the RRC connection to the TN is not possible. The state in which the RRC connection is not possible may include a communication congestion due to an event, a situation in which a disaster occurs, a situation in which a control channel (RACH: Random Access Channel, or the like) does not get through (RACH does not reach), a situation in which RRC Release (RRC Connection Release) is performed, or the like. This makes it possible to ensure communication with the NTN even in a situation in which the connection to the TN is difficult.

### Option

When the RRC connection to the TN is not possible, the UE 200 may preferentially reselect an NTN cell. Thus, the consumption of radio resources in the UE 200 for the RRC connection to the TN can be suppressed while performing communication with the NTN.

### (3.2.4) Operation Example 4

An operation example in which information indicating a type of a neighboring cell is transmitted from the network to the UE 200 via a system information block (SIB) will be described.

The network may broadcast information indicating a type of a neighboring cell (neighboring NTN cell type or neighboring TN cell type) in the form of the system information block (SIB). That is, the network may broadcast the SIB including the type information indicating the type of the cell adjacent to the cell in which the UE 200 resides. The neighboring cell may be interpreted as an NTN cell or a TN cell adjacent to the cell in which the UE 200 resides. The network may be interpreted as the TN or the NTN. In this case, the control unit of the UE 200 may receive the SIB including the type information.

The SIB may include information that may be required to communicate within the cell in which the UE 200 resides. The SIB may include SIB3 and/or SIB4. The network may broadcast information indicating a type of a neighboring cell in the form of SIB3 and/or SIB4. That is, the network may broadcast the SIB3 and/or the SIB4 including the type information indicating the type of the cell adjacent to the cell in which the UE 200 resides. In this case, the control unit of the UE 200 may receive the SIB3 and/or the SIB4 including the type information.

The SIB3 may include intraFreqNeighCellInfo as the cell re-selection information common to cell re-selection. The intraFreqNeighCellInfo may include physCellId, q-OffsetCell, q-RxLevMinOffsetCell, q-RxLevMinOffsetCellSUL, q-QualMinOffsetCell, and the like as parameters related to intra-frequency neighboring cells.

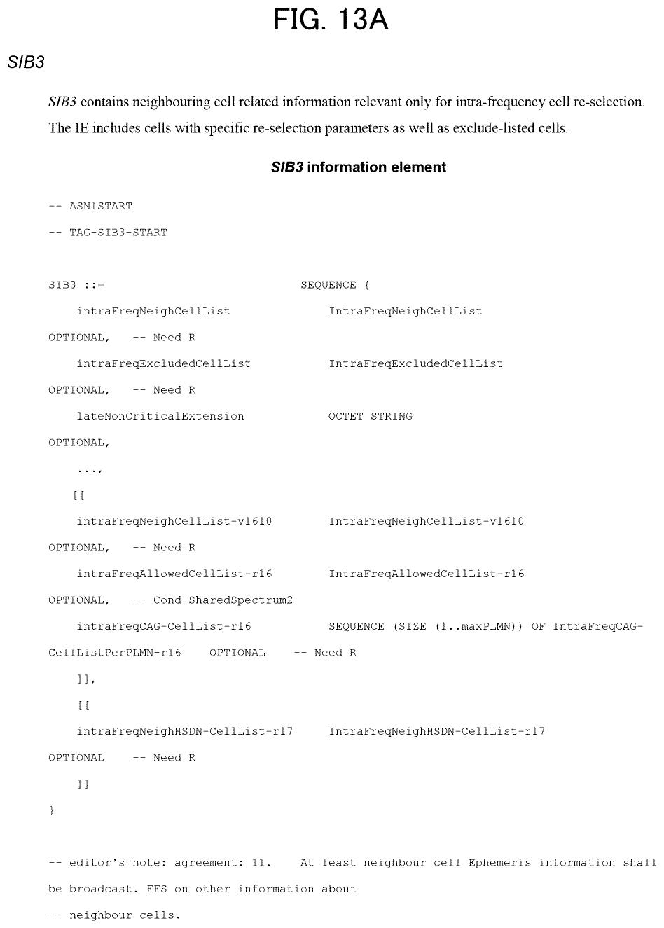

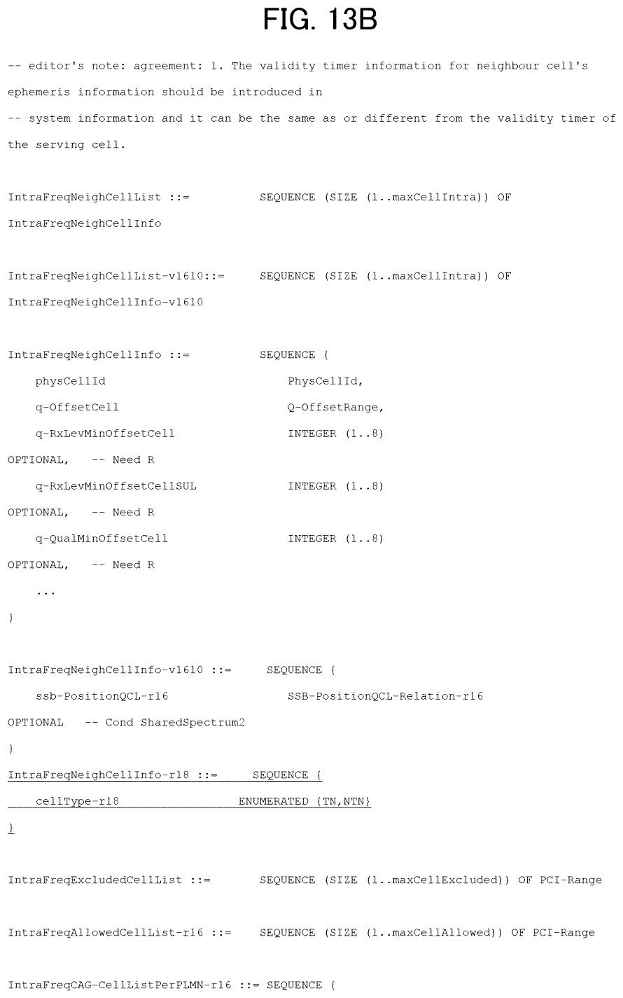

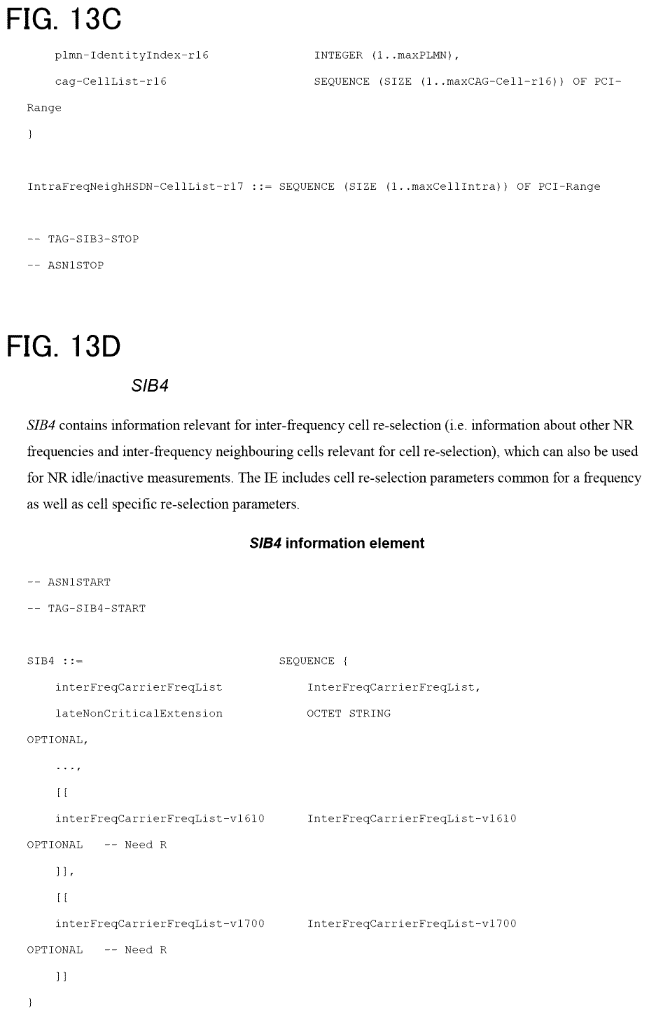

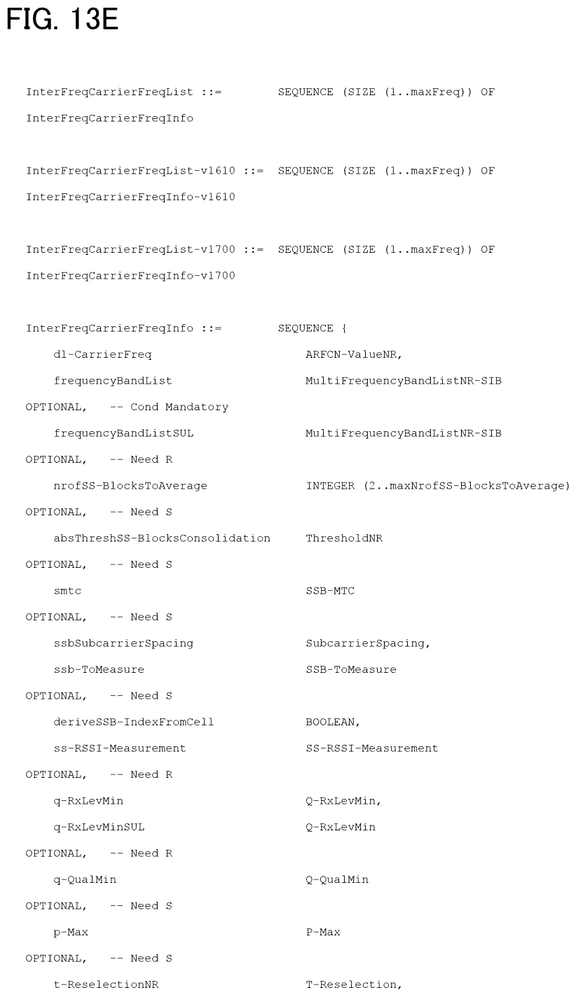

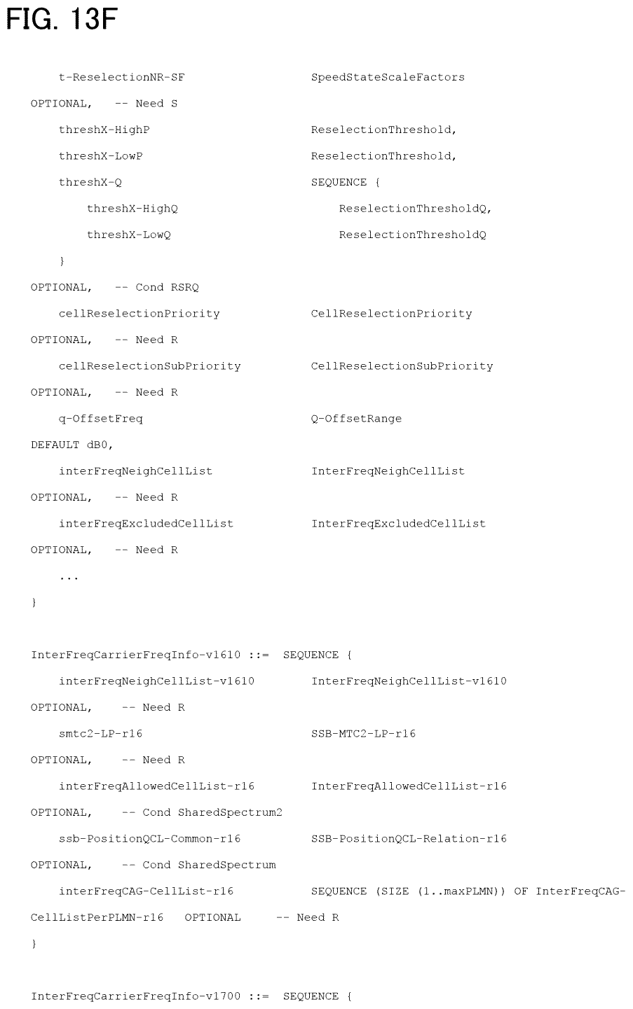

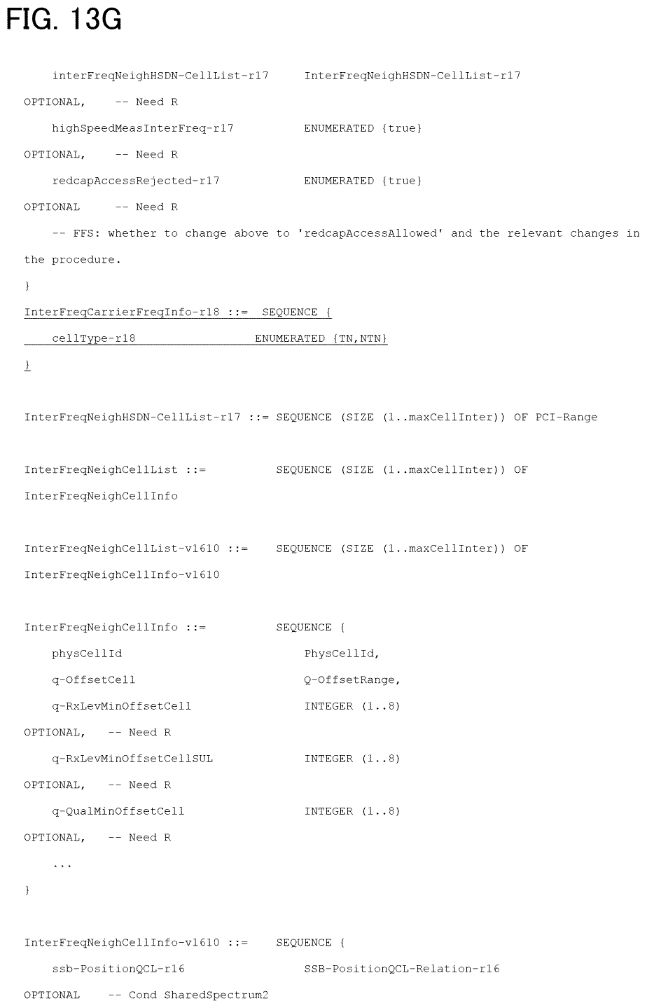

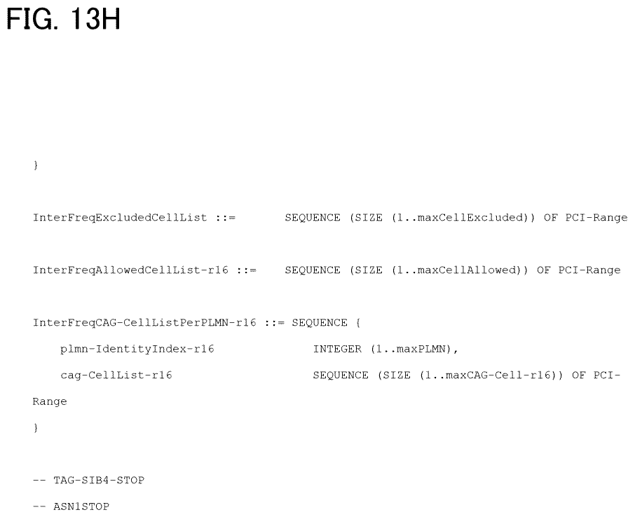

In addition, the SIB3 may include an indicator of the NTN, or an indicator of the TN (see underlined parts in FIG. 13B).

The SIB4 may include interFreqCarrierFreqInfo as neighboring cell related information. The inter FreqCarrierFreqInfo may include dl-CarrierFreq, FrequencyBandList, FrequencyBandListSUL, and the like as parameters for intra-frequency cell re-selection.

In addition, the SIB4 may include an indicator of the NTN, or an indicator of the TN (see underlined parts in FIG. 13G).

According to operation example 4, even when the UE 200 is in an idle state, it is possible to change the frequency measurement of the NTN cell or TN cell to be ON or OFF by acquiring the above type information. Further, according to operation example 4, even when the UE 200 is in an RRC INACTIVE state, it is possible to change the frequency measurement of the NTN cell or TN cell to be ON or OFF by acquiring the above type information.

In the RRC CONNECTED state, the network may transmit the above type information to the UE 200 by using an RRC message.

### (3.2.5) Operation Example 5

An operation example in which location information of neighboring cells and the like is transmitted from the network to the UE 200 via a system information block (SIB) will be described.

FIG. 10 is a diagram explaining a communication sequence example of operation example 5. The NTN cell may broadcast the location information of the neighboring TN cell and/or the neighboring base station, and the location information of the TN cell and/or the base station in the neighboring NTN cell via the SIB (step S11). The reception unit of the UE 200 may receive the SIB including the location information. The SIB may be broadcast by the TN cell.

The neighboring TN cell may be interpreted as a TN cell adjacent to the TN cell in which the UE 200 resides. The neighboring base station may be interpreted as a base station adjacent to the TN cell in which the UE 200 resides. The neighboring NTN cell may be interpreted as an NTN cell adjacent to the NTN cell in which the UE 200 resides.

The UE 200 may compare the location of the UE 200 with the location of the TN cell, and determine whether the distance between the UE 200 and the TN cell is longer than a predetermined distance (step S12).

If the distance between the UE 200 and the TN cell is longer than a predetermined distance, the UE 200 may turn ON the measurement of the NTN cell. Specifically, the control unit of the UE 200 determines whether the distance from the location of the cell or the base station, which is adjacent to the cell in which the UE 200 resides, to the UE 200 is longer than a predetermined distance (threshold value), based on the location of the UE 200 acquired using a GPS (Global Positioning System), a GNSS (Global Navigation Satellite System), or the like, and on the location included in the SIB received by the reception unit of the UE 200.

As a result of the determination, if the distance to the UE 200 is longer than a predetermined distance (threshold value), the control unit of the UE 200 may turn ON the measurement of the second cell (NTN cell) (step S13). In this case, at least one of the TN cell search and the TN cell measurement may be turned OFF. This makes it possible for the UE 200 to start the measurement of the NTN cell before establishing the RRC connection, thereby suppressing the consumption of radio resources associated with the TN cell search or the TN cell measurement.

If the distance between the UE 200 and the TN cell is shorter than a predetermined distance, the UE 200 may turn ON the measurement of the TN cell. In this case, at least one of the NTN cell search and the NTN cell measurement may be turned OFF.

The NTN cell or the TN cell may include a predetermined distance (threshold value) described above in the SIB and broadcast such an SIB. The reception unit of the UE 200 may receive the SIB including the threshold value.

### Option 1

If the distance between the UE 200 and the TN cell is longer than a predetermined distance, the control unit of the UE 200 may turn ON a measurement of the second cell (NTN cell) after determining whether the quality of the TN cell is higher than a predetermined threshold value.

### Option 1-1

If the distance between the UE 200 and the TN cell is longer than a predetermined distance and the quality of the TN cell is higher than a predetermined threshold value, the UE 200 can keep the measurement of the NTN cell OFF instead of turning ON.

### Option 1-2

If the distance between the UE 200 and the TN cell is longer than a predetermined distance and the quality of the TN cell is lower than a predetermined threshold value, the UE 200 may turn ON the measurement of the NTN cell.

According to option 1, even if the distance between the UE 200 and the TN cell is long, the UE 200 can preferentially connect to the TN cell, when the line of sight from the UE 200 to the TN cell is good and the communication quality is high. This makes it possible to prevent the UE 200 from continuing communication with the NTN, thereby suppressing the consumption of radio resources in the UE 200.

In the RRC CONNECTED state, the network may transmit the above location information to the UE 200 by using an RRC message.

### (3.2.6) Operation Example 6

The network may divide an NTN cell into a plurality of sub-areas. The network may divide a geographic area covered by an NTN cell into a plurality of sub-areas. The network may broadcast to the UE 200 the information indicating that a TN cell exists near the divided sub-area. Further, the network may broadcast the information to the UE 200 via an RRC message. The plurality of sub-areas may be interpreted as sub-mapped cells or sub-geographical areas.

Upon receiving the information indicating that the TN cell exists, the UE 200 may turn ON a frequency measurement of the TN cell when entering (camping in or performing handover to) a sub-area of the divided sub-areas where the TN cell exists in the neighborhood. Specifically, the UE 200 may turn ON the frequency measurement of the TN cell when performing a handover to the sub-area that is the most adjacent to the TN cell in the divided sub-areas. However, the timing of turning ON the frequency measurement of the TN cell is not limited to this configuration, and may be possible as long as the UE 200 resides in a sub-area where the TN cell exists in the neighborhood.

Upon receiving the information indicating that the TN cell exists, the UE 200 may turn OFF a frequency measurement of the TN cell when entering (camping in or performing handover to) a sub-area of the divided sub-areas where no TN cell exists in the neighborhood. Specifically, the UE 200 may turn OFF the frequency measurement of the TN cell when entering a sub-area of the divided sub-areas where no TN cell exists in the neighborhood. The sub-area where no TN cell exists in the neighborhood may be interpreted as a sub-area other than a sub-area that is the most adjacent to the TN cell.

### (3.2.7) Operation Example 7

If the distance to the TN cell is shorter than a predetermined distance, the transmission unit of the UE 200 may transmit a measurement report or a location report to the network in the RRC_CONNECTED state. The transmission unit of the UE 200 may transmit a measurement report or a location report to the network by using an RRC message. The UE 200 may include information indicating the quality of the TN cell and information indicating the location of the TN cell in the measurement report or in the location report.

If the distance to the TN cell is shorter than a predetermined distance, the transmission unit of the UE 200 may transmit to the network in the RRC CONNECTED state, the UEAsistanceInfo including the information (preference) on a network to be connected to the TN cell with priority.

The network may cause the UE to perform a handover to the TN cell, based on the information indicating the quality of the TN cell and the information indicating the location of the TN cell which are included in the measurement report or in the location report transmitted from the UE.

If the distance to the TN cell is farther than a predetermined distance, the transmission unit of the UE 200 may transmit a measurement report or a location report to the network in the RRC_CONNECTED state. The transmission unit of the UE 200 may transmit a measurement report or a location report to the network by using an RRC message. The UE 200 may include information indicating the quality of the TN cell and information indicating the location of the TN cell in the measurement report or in the location report.

If the distance to the TN cell is longer than a predetermined distance, the transmission unit of the UE 200 may transmit to the network in the RRC CONNECTED state, the UEAsistanceInfo including the information (preference) on a network to be connected to the NTN cell with priority.

The network may cause the UE to perform a handover to the NTN cell, based on the information indicating the quality of the TN cell and the information indicating the location of the TN cell which are included in the measurement report or in the location report transmitted from the UE.

### (3.2.8) Operation Example 8

If the distance to the TN cell is shorter than a predetermined distance, the UE 200 may perform cell re-selection with giving priority to the TN cell in the RRC_IDLE state. This makes it possible for the UE 200 to communicate with the TN cell preferentially, thereby suppressing unnecessary communication with the NTN cell.

In a case where the quality of the TN cell is higher than a predetermined threshold value, the UE 200 may preferentially select the TN cell even if the quality of the TN cell is lower than the quality of the NTN cell. This makes it possible for the UE 200 to communicate with the TN cell preferentially, thereby suppressing unnecessary communication with the NTN cell.

If the distance between the UE and the TN cell is longer than a predetermined distance, the UE 200 may preferentially select the NTN cell. This makes it possible for the UE 200 to communicate with the NTN cell preferentially, thereby suppressing unnecessary communication with the TN cell.

### (4) Operation and Effect

According to the embodiment described above, the following operation and effect are obtained. Specifically, the UE according to the embodiment of the present disclosure may include: a control unit that selects a first network forming a first cell, or a second network located at an altitude higher than the first network and forming a second cell as a network to which a terminal connects; and a transmission unit that transmits assistance information including information on the selected first network or the selected second network to a network.

Thus, when the user optionally selects a network to be connected with priority, unnecessary communication with an unselected network be suppressed can while communicating with the selected network. Therefore, when the connection to the TN is selected, the connection of the UE 200 to the NTN is stopped, thereby suppressing the consumption of radio resources (frequency bandwidth, transmission power, or the like) in the UE 200 for the UE 200 to continue communication with the NTN. In addition, when the connection to the NTN is selected, the connection of the UE 200 to the TN is stopped, thereby suppressing the consumption of radio resources in the UE 200 for the UE 200 to continue communication with the TN.

The UE according to the embodiment of the present disclosure may include: a control unit that determines whether a quality of a first cell is higher than a threshold value when a terminal connects to the first cell formed by a first network; and a reception unit that stops a frequency measurement of a second cell formed by a second network located at an altitude higher than the first network when determining that a quality of the first cell is higher than a threshold value.

This makes it possible to suppress the consumption of radio resources in the UE 200 for the TN cell search while performing communication with the NTN, and also to suppress the amount of communication between the TN cell and the UE 200.

The reception unit may start a frequency measurement of the second cell when the terminal is in a “camped on any cell” state in the first cell.

Thus, in a case where the UE 200 is in a “camped on any cell” state in any TN cell, the UE 200 can connect to the NTN, instead of the TN cell whose quality is lower than a predetermined value, by restarting the frequency measurement of the NTN. Therefore, the consumption of radio resources in the UE 200 can be suppressed by stopping the connection to the TN cell while ensuring communication with the NTN.

The control unit may receive a system information block (SIB) including type information indicating a type of a cell adjacent to a cell in which the terminal resides.

This makes it possible for the UE 200 to start a measurement of the neighboring cell which can be connected before establishing an RRC connection, thereby suppressing the consumption of radio resources associated with the measurement of a cell to which communication is unnecessary.

The control unit may start a measurement of the second cell if a distance from a location of a cell or a base station adjacent to a cell in which the terminal resides to the terminal is longer than a threshold value.

This makes it possible for the UE 200 to start a measurement of the neighboring cell (NTN cell) which can be communicated, thereby suppressing the consumption of radio resources associated with the measurement of the neighboring cell (TN cell) to which communication is unnecessary.

The transmission unit may transmit the assistance information to a network if a distance from a location of a cell or a base station adjacent to a cell in which the terminal resides to the terminal is shorter than a threshold value, when the connection is performed.

This makes it possible for the UE 200 to start a measurement of the neighboring cell that can be communicated before establishing the RRC connection, thereby suppressing the consumption of radio resources associated with the measurement of a neighboring cell to which communication is unnecessary.

### (5) Other Embodiments

Although the embodiment has been described above, it is obvious to those skilled in the art that the present invention is not limited to the description of the embodiment and that various modifications and improvements thereof are possible.

In the above description, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

In the present disclosure, the terms such as “precoding”, “precoder”, “weight (precoding weight)”, “quasi-co-location (QCL)”, “Transmission Configuration Indication state state)”, (TCI “spatial relation”, “spatial domain f filter”, “transmission power”, “phase rotation”, “antenna port”, “antenna port group”, “layer”, “the number of layers”, “rank”, “resource”, “resource set”, “resource group”, “beam”, “beam width”, “beam angle”, “antenna”, “antenna element”, “panel”, and so on can be used interchangeably.

The block diagrams (FIGS. 4 and 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

Furthermore, the above-described gNB 100, UE 200 and AMF 50 (the apparatus) may function as a computer that executes the processes of the radio communication method of the present disclosure. FIG. 11 is a diagram to show an example of a hardware structure of the gNB 100 and UE 200. As shown in FIG. 11, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function of the apparatus (see FIGS. 4 and 5) is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling,

Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by the gNB 100 may, in some cases, be performed by an upper node thereof. In a network including one or a plurality of network nodes with the gNB 100, it is clear that various operations that are performed to communicate with the UE 200 can be performed by the gNB 100 and other network nodes (for example, Mobility Management Entities (MMEs), Serving-Gateways (S-GWs), and so on may be possible, but these are not limiting) other than the gNB 100, or combinations of these. According to the above, a case is described in which there is a single network node other than the gNB 100. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. The gNB 100 may be referred to as the terms such as a “macro cell,” a “small cell,” a “femto cell,” a “pico cell,” and so on.

A gNB 100 can accommodate one or a plurality of (for example, three) cells (which may be referred to as sectors). When a gNB 100 accommodates a plurality of cells, the entire coverage area of the gNB 100 can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a gNB 100 and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a gNB 100 and a mobile station may be referred to as a “transmitting apparatus,” a “receiving apparatus,” a “communication apparatus,” and so on. Note that at least one of a gNB 100 and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a gNB 100 and a mobile station also includes an apparatus which does not necessarily move during communication operation. For example, at least one of a gNB 100 and a mobile station may be an Internet of Things (IOT) device such as a sensor.

Furthermore, the gNB 100 in the present disclosure may be interpreted as a mobile station (user terminal, hereinafter the same). For example, each aspect/embodiment of the present disclosure may be applied to the structure that replaces a communication between a gNB 100 and a mobile station with a communication between a plurality of mobile stations (for example, which may be referred to as “Device-to-Device (D2D),” “Vehicle-to-Everything (V2X),” and the like). In this case, the mobile station may have the functions of the gNB 100 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the mobile station in the present disclosure may be interpreted as a gNB 100. In this case, the gNB 100 may have the functions of the mobile station described above. A radio frame may be constituted of one or a plurality of frames in the time domain. Each of one or a plurality of frames may be referred to as a “subframe” in the time domain. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a gNB 100 performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

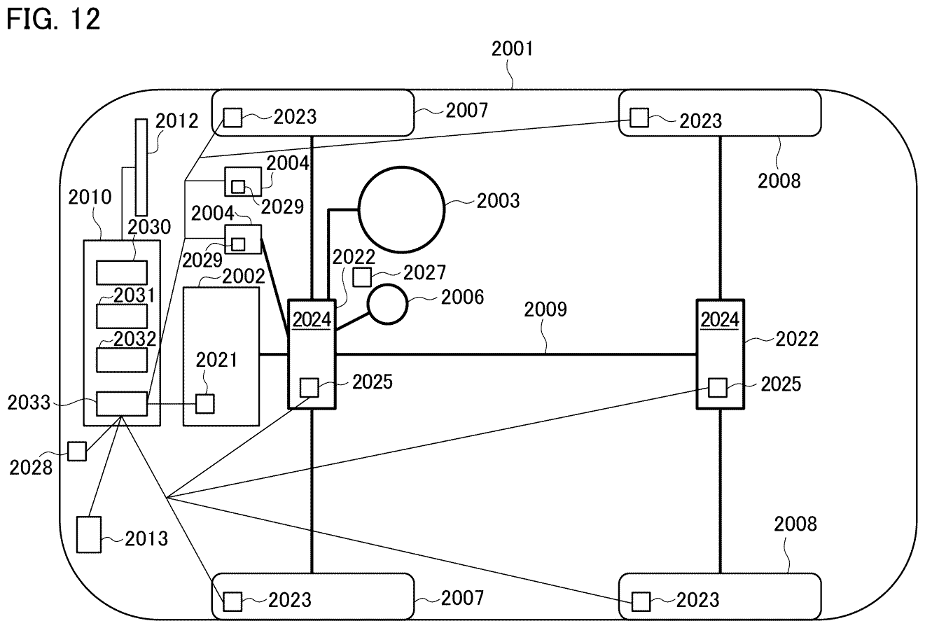

FIG. 12 shows an example of a configuration of a vehicle 2001. As shown in FIG. 12, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e. g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices radio communication. through The communication module 2013 may be internal to or external to the electronic control unit 2010. The external devices may include, for example, a gNB 100, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

### Supplementary Note

The terminal of the present embodiment may be configured as a terminal as described in the following sections.

### Section 1

A terminal includes: a control unit that selects a first network forming a first cell, or a second network located at an altitude higher than the first network and forming a second cell as a network to which a terminal connects; and a transmission unit that transmits assistance information including information on the selected first network or the selected second network to a network.

### Section 2

A terminal includes: a control unit that determines whether a quality of a first cell formed by a first network is higher than a threshold value; and a reception unit that stops a frequency measurement of a second cell formed by a second network located at an altitude higher than the first network when determining that a quality of the first cell is higher than a threshold value.

### Section 3

The terminal according to claim 2, wherein the reception unit starts a frequency measurement of the second cell when the terminal is in a “camped on any cell” state in the first cell.

### Section 4

The terminal according to any one of claims 1 to 3, wherein the control unit receives a system information block (SIB) including type information indicating a type of a cell adjacent to a cell in which the terminal resides.

### Section 5

The terminal according to any one of claims 1 to 4, wherein the control unit starts a measurement of the second cell if a distance from a location of a cell or a base station adjacent to a cell in which the terminal resides to the terminal is longer than a threshold value.

### Section 6

The terminal according to claim 1, wherein the transmission unit transmits the assistance information to a network if a distance from a location of a cell or a base station adjacent to a cell in which the terminal resides to the terminal is shorter than a threshold value when the connection is performed.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### REFERENCE SIGNS LIST

10 radio communication system
20 NG-RAN
30 core network
40 radio communication node
100 gNB
100X NTN gateway
110 reception unit
120 transmission unit
130 control unit
150 artificial satellite
200 UE
210 radio signal transmission and reception unit
220 amplifier unit
230 modulation and demodulation unit
240 control signal and reference signal processing unit
250 encoding/decoding unit
260 data transmission and reception unit
270 control unit
310 reception unit
320 transmission unit
330 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 left and right front wheels
2008 left and right rear wheels
2009 axle
2010 electronic control unit
2012 information service unit
2013 communication module
2021 current sensor
2022 rotational speed sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a control unit that selects a first network forming a first cell, or a second network located at an altitude higher than the first network and forming a second cell as a network to which a terminal connects; and
a transmission unit that transmits assistance information including information on the selected first network or the selected second network to a network.

2. A terminal comprising:
a control unit that determines whether a quality of a first cell formed by a first network is higher than a threshold value; and
a reception unit that stops a frequency measurement of a second cell formed by a second network located at an altitude higher than the first network when determining that a quality of the first cell is higher than a threshold value.

3. The terminal according to claim 1, wherein the reception unit starts a frequency measurement of the second cell when the terminal is in a “camped on any cell” state in the first cell.

4. The terminal according to claim 1, wherein the control unit receives a system information block (SIB) including type information indicating a type of a cell adjacent to a cell in which the terminal resides.

5. The terminal according to claim 1, wherein the control unit starts a measurement of the second cell if a distance from a location of a cell or a base station adjacent to a cell in which the terminal resides to the terminal is longer than a threshold value.

6. The terminal according to claim 1, wherein the transmission unit transmits the assistance information to a network if a distance from a location of a cell or a base station adjacent to a cell in which the terminal resides to the terminal is shorter than a threshold value, when the connection is performed.
